(19) United States
(12) Patent Application Publication
(10) Pub. No.: US 2012/0127475 A1
(43) Pub. Date: May 24, 2012

(54) APPARATUSES, SYSTEMS, AND METHODS FOR LOW-COHERENCE INTERFEROMETRY (LCI)

(75) Inventors: Adam Wax, Chapel Hill, NC (US); William J. Brown, Durham, NC (US)

(73) Assignee: DUKE UNIVERSITY, Durham, NC (US)

(21) Appl. No.: 13/305,095

(22) Filed: Nov. 28, 2011

Related U.S. Application Data
(63) Continuation of application No. 12/210,620, filed on Sep. 15, 2008, now abandoned.
(60) Provisional application No. 60/971,980, filed on Sep. 13, 2007.

(51) Int. Cl. G01B 9/02

(52) U.S. Cl. 356/479

(57) ABSTRACT

Low-coherence interferometry (LCI) techniques enable acquisition of structural and depth information of a sample. A “swept-source” (SS) light source may be used. The swept-source light source can be used to generate a reference signal and a signal directed towards a sample. Light scattered from the sample is returned as a result and mixed with the reference signal to achieve interference and thus provide structural information regarding the sample. Depth information about the sample can be obtained using Fourier domain concepts as well as time domain techniques. In another embodiment, an a/LCI system and method is provided that is based on a time domain system and employs a broadband light source. The systems and processes disclosed herein can be used for biomedical applications, included measuring cellular morphology in tissues and in vitro, as well as diagnosing intraepithelial neoplasia, and assessing the efficacy of chemopreventive and chemotherapeutic agents.

### RELATED APPLICATIONS

This patent application is a continuation of and claims priority to U.S. patent application Ser. No. 12/210,620, filed on Sep. 15, 2008 and entitled “Apparatuses, Systems, and Methods for Low-Coherence Interferometry (LCI),” which is incorporated herein by reference in its entirety and which further claims priority to U.S. Provisional Patent Application Ser. No. 60/971,980, filed on Sep. 13, 2007 and entitled “Systems and Methods for Angle-Resolved Low Coherence Interferometry,” which is incorporated herein by reference in its entirety.

### BACKGROUND

1. Field of the Invention

The technology of the present application relates generally to low-coherence interferometry (LCI) and obtaining structural and depth-resolved information about a sample using LCI. The technology includes angle-resolved-based LCI (a/LCI), Fourier-based LCI (f/LCI), and Fourier and angle-resolved-based LCI (fa/LCI) apparatuses, systems, and methods.

2. Technical Background

Examining the structural features of cells is essential for many clinical and laboratory studies. The most common tool used during examination for the study of cells has been the microscope. Although microscopic examination has led to great advances in understanding cells and their structure, it is inherently limited by the artifacts of preparation. The characteristics of the cells can only been seen at one moment in time with their structural features altered because of the addition of chemicals. Further, invasion is necessary to obtain the cell sample for examination.

Thus, light scattering spectroscopy (LSS) was developed to allow for in vivo examination applications, including cells. The LSS technique examines variations in the elastic scattering properties of cell organelles to infer their sizes and other dimensional information. In order to measure cellular features in tissues and other cellular structures, it is necessary to distinguish the singly scattered light from diffused light, which has been multiply scattered and no longer carries easily accessible information about the scattering objects. This distinction or differentiation can be accomplished in several ways, such as the application of a polarization grating, by restricting or limiting studies and analysis to weakly scattering samples, or by using modeling to remove the diffused component(s).

As an alternative approach for selectively detecting singly scattered light from sub-surface sites, low-coherence interferometry (LCI) has also been explored as a method of LSS. LCI typically utilizes a broadband light source with low temporal coherence, such as a broadband white light source, for example. Interference is achieved when the path length delays of the interferometer are matched with the coherence time of the light source. The axial resolution of the system is determined by the coherence length of the light source and is typically in the micrometer range suitable for the examination of tissue samples. Experimental results have shown that using a broadband light source and its second harmonic allows the recovery of information about elastic scattering using LCI. LCI has used time domain depth scans by moving the sample with respect to a reference arm directing the light onto the sample to receive scattering information from a particular point on the sample. Thus, scan times were on the order of five (5) to thirty (30) minutes in order to completely scan the sample.

Angle-resolved LCI (a/LCI) has been developed as a means to obtain sub-surface structural information regarding the sizes of a cell and its components such as nuclei and mitochondria. a/LCI has been successfully applied to measuring cellular morphology in tissues and in vitro as well as diagnosing intraepithelial neoplasia and assessing the efficacy of chemopreventive agents in an animal model of carcinogenesis. a/LCI has also been used to prospectively grade tissue samples without tissue processing, demonstrating the potential of the technique as a biomedical diagnostic.

In a/LCI, light is split into a reference beam and a sample beam, wherein the sample beam is projected onto the sample at an angle to examine the angular distribution of scattered light. The a/LCI technique combines the ability of LCI to detect singly scattered light from sub-surface sites with the capability of light scattering methods to obtain structural information with sub-wavelength precision and accuracy to construct depth-resolved tomographic images. Structural information is determined by examining the angular distribution of the back-scattered light using a single broadband light source that is mixed with a reference field with an angle of propagation. The size distribution of the cell and its components such as nuclei or mitochondria can be determined by comparing the oscillatory part of the measured angular distributions to predictions.

Initial prototype and second generation a/LCI systems required approximately thirty (30) and five (5) minutes respectively to obtain similar data. The method of obtaining angular specificity to obtain structural information about a sample was achieved by causing the reference beam of the interferometry to cross the detector plane at a variable angle. However, these a/LCI systems relied on time domain depth scans just as provided in previous LCI-based systems. The length of the reference arm of the interferometer had to be mechanically adjusted to achieve serial scanning of the detected scattering angle to obtain depth information regarding a sample.

### SUMMARY OF THE DETAILED DESCRIPTION

Embodiments disclosed herein involve low-coherence interferometry (LCI) techniques which enable acquisition of structural and depth information regarding a sample of interest at rapid rates. The acquisition rate is sufficiently rapid to make in vivo applications feasible. Biomedical applications of the embodiments disclosed herein include using the a/LCI systems and processes described herein for measuring cellular morphology in tissues and in vitro as well as diagnosing intraepithelial neoplasia, and assessing the efficacy of chemopreventive and chemotherapeutic agents. Prospectively grading tissue samples without tissue processing can also be accomplished using the embodiments disclosed herein, demonstrating the potential of the technique as a biomedical diagnostic.

In one embodiment, a “swept-source” (SS) light source is used in LCI to obtain structural and depth information about a sample. The swept-source light source is used to generate a reference signal and a signal directed towards a sample. Light scattered from the sample is returned as a result and mixed with the reference signal to achieve interference and thus provide structural information regarding the sample. By “swept-source,” the light source is controlled to sweep emitted light over a given range of wavelengths in time. Because the emitted light is broken up into particular wavelengths or narrower ranges of wavelengths during emission, scattered light returned from the sample is known to be in response to a particular wavelength or range of wavelengths. Thus, the returned scattered light is spectrally-resolved and depth-resolved, because the returned light is in response to the light source emitted light over a spectral domain. This is opposed to a wider or broadband light source that generates a wider range wavelengths of light in one light emission in time, wherein the returned scattered light from the sample contains scattered light at a wider range of wavelengths. In this instance, a spectrometer may be required to spectrally-resolve the returned scattered light. However, when using a swept-source light source, the series of returned scattered lights from the sample at each wavelength are already in the spectral domain to provide spectrally-resolved information about the sample.

Several LCI embodiments employing a swept-source light source are disclosed herein. For example, one LCI embodiment disclosed herein involves using a swept-source light source in angle-resolved low-coherence interferometry (a/LCI). This is also referred to as swept-source a/LCI (SS a/LCI). The swept-source light source is employed to generate a reference signal and a signal directed towards a sample over the swept range of wavelengths or ranges of wavelengths. The light is either directed to strike the sample at an angle, or the light source or another component in the system (e.g., a lens) is moved to direct light onto the sample at a plurality of angles. This causes a set of scattered light to be returned and dispersed from the sample at a plurality of angles, thereby representing spectrally-resolved and angle-resolved scattered information about the sample from a plurality of points on the sample.

The spectrally-resolved and angle-resolved scattered information about the sample can be detected at a single scattering angle to provide a single scattering plane (i.e., 1-dimension) of spectrally-resolved and angle-resolved scattered information about the sample. Alternatively, the spectrally-resolved and angle-resolved scattered information about the sample can be detected at a plurality or range of angles to provide two-dimensional spectrally-resolved and angle-resolved scattered information about the sample. Capture of two-dimensional spectrally-resolved and angle-resolved scattered information from multiple scattering angles allows generation of more information about the sample under study and/or information with higher signal-to-noise ratio.

Depth information about the sample can be obtained using Fourier domain concepts as well as time domain techniques when using SS a/LCI. For example, in one manner of using time domain techniques to obtain depth information, the sample can be moved with respect to the light source to direct light at different planes within the sample. The resulting scattered light is processed to determine depth characteristics about the sample of interest. When using Fourier techniques as an example, the spectrally-resolved distribution of the scattered light returned from the sample as a result of the light emitted by the swept-source light source is converted into the Fourier domain. This allows obtaining depth-resolved information about the sample. Because the light source is swept, a spectrometer is not required to obtain spectral information about the sample, because the returned scattered light from the sample is already in the spectral domain as a result of a series of data acquisitions collected in narrower wavelengths or ranges emitted by the light source during its sweep. Scattering size characteristic information about the sample can be obtained by processing the spectrally-resolved and depth-resolved profile.

In another embodiment disclosed herein, a multiple channel time-domain a/LCI system and method is provided employing a broadband light source. This technique physically scans the depth in the time domain, but unlike other previous a/LCI systems and methods, the angular distribution of scattered light returned from the sample is detected at a plurality of angles simultaneously to obtain angle-resolved information about the sample. The light source generates a reference signal which is directed towards a sample. The light is either directed to strike at an angle, or the light source or another component in the system (e.g., a lens) is moved to direct the light onto the sample at a plurality of angles. This causes a set of scattered lights to be returned from the sample scattered at a plurality of angles off of the sample, thereby representing angle-resolved scattered information about the sample from a plurality of points on the sample.

In yet another embodiment, a Fourier LCI system and method with serial detection of angular scatter information about the sample are provided. An a/LCI system is used to collect the angular distribution information from the sample in a serial fashion by moving the angle at which the light from the light source is directed to the sample. Depth information about a sample can be determined in the spectral domain using a Fourier domain approach with either a broadband light source with a spectrometer or a swept-source light source with a detection device. For the broadband light source, the system and method do not use the time domain approach and thus movement of the reference arm with respect to the sample to obtain time domain-based data is not needed. This system and method can also be implemented with a swept-source light source in place of the broadband light source.

In another embodiment, a multi-spectral a/LCI approach can be used to obtain structural and depth-resolved information about a sample. A narrower band light source is employed to generate a reference signal and a signal directed towards a sample a number of times to obtain a series of data acquisitions. The light may be emitted directly onto the sample for LCI or at a scatter angle for a/LCI. The reference signal and the returned scattered light from the sample are mixed or cross-correlated to provide spectral information about the sample. Performing this method numerous times at a plurality of wavelengths provides spectral information about the sample. Depth information about the sample can be obtained using Fourier domain concepts as well as time domain techniques.

Various apparatuses and systems can be employed in the aforementioned systems and methods. For example, in one embodiment, the apparatus is based on a light splitter system that splits the emitted swept-source light into a reference path and a sample path using a series of splitters and lenses. In another embodiment, an optical fiber probe can be used to deliver light from a swept-source light source and collect the scattered light from the sample of interest. A fiber optic bundle collector comprised of a plurality of optical fibers is particularly well-suited for detecting two-dimensional angle-resolved spectral information about the sample.

The LCI-based apparatuses, systems, and methods described above and in this application can be clinically viable methods for assessing tissue health without the need for tissue extraction via biopsy or subsequent histopathological evaluation. These LCI-based apparatuses, systems, and methods can be applied for a number of purposes including, but not limited to: early detection and screening for dysplastic tissues, disease staging, monitoring of therapeutic action, and guiding the clinician to biopsy sites. Some potential target tissues include the esophagus, the colon, the stomach, the oral cavity, the lungs, the bladder, and the cervix. The non-invasive, non-ionizing nature of the optical and LCI probe means that it can be applied frequently without adverse affect. The provision of rapid results through the use of the a/LCI systems and processes disclosed herein greatly enhance its widespread applicability for disease screening.

### BRIEF DESCRIPTION OF THE FIGURES

FIG. 1 is a schematic diagram of an exemplary swept-source (SS) angle-resolved low-coherence interferometry (LCI) (SS a/LCI) apparatus and system that is used to detect information about a sample of interest;

FIG. 2 is a schematic diagram illustrating the angular light directed to the sample and detection of the angular scattered light returned from the sample using the SS a/LCI system illustrated in FIG. 1;

FIG. 3 is a flowchart illustrating an exemplary process for detecting spatially and depth-resolved information about the sample using the exemplary SS a/LCI apparatus and system of FIGS. 1 and 2;

FIG. 4 is an illustration of an angular distribution plot of raw and filtered data regarding scattered sample signal intensity as a function of angle in order to recover size information about the sample;

FIG. 5A is an illustration of the filtered angular distribution of the scattered sample signal intensity compared to the best fit Mie theory to determine size information about the sample;

FIG. 5B is a Chi-squared minimization of size information about the sample to estimate the diameter of cells in the sample;

FIG. 6A is a schematic diagram of exemplary fiber optic-based swept-source (SS) angle-resolved low-coherence interferometry (LCI) (SS a/LCI) apparatus and system that is used to detect information about a sample of interest;

FIG. 6B is another schematic diagram of the exemplary fiber optic-based swept-source (SS) angle-resolved low-coherence interferometry (LCI) (SS a/LCI) apparatus and system of FIG. 6A;

FIG. 7A is a cutaway view of an a/LCI fiber optic probe tip that is employed by the SS a/LCI system illustrated in FIGS. 6A and 6B;

FIG. 7B illustrates the location of the fiber probe in the SS a/LCI system illustrated in FIG. 7A;

FIG. 8 is a schematic diagram of an exemplary swept-source multiple angle SS a/LCI (MA SS a/LCI) apparatus and system that is used to detect information about a sample of interest;

FIG. 9 is a schematic diagram illustrating the angular light directed to the sample and detection of the angularly distributed scattered light returned from the sample in two dimensions using the MA SS a/LCI system illustrated in FIG. 8;

FIG. 10 is an exemplary model of a two-dimensional image of a diffraction pattern from a sample acquired using the MA SS a/LCI system of FIG. 8;

FIG. 11 is a schematic diagram of an exemplary optic fiber breakout from a fiber optic cable employed in the MA SS a/LCI apparatus and system of FIG. 8;

FIG. 12 is a schematic diagram of relative fiber positions of an endoscopic fiber optic detection device that can be employed in the MA SS a/LCI apparatus and system of FIG. 8;

FIG. 13 is a schematic diagram of a multiple channel time domain a/LCI apparatus and system that is used to detect information about a sample of interest;

FIG. 14 is a schematic diagram of an alternative multiple channel time domain a/LCI apparatus and system that is used to detect information about a sample of interest;

FIG. 15 is a schematic diagram of an alternative time domain a/LCI apparatus and system that collects angular information about the sample in serial fashion, but collects depth information using Fourier domain techniques;

FIG. 16 is a schematic diagram of a fiber optic-based time domain a/LCI apparatus and system that collects angular information about the sample in serial fashion, but collects depth information using Fourier domain techniques;

FIG. 17 is a schematic diagram of a multi-spectral a/LCI apparatus and system; and

FIG. 18 is a schematic diagram of a fiber optic-based multi-spectral a/LCI apparatus and system.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed herein involve new low-coherence interferometry (LCI) techniques which enable acquisition of structural and depth information regarding a sample of interest at rapid rates. A sample can be tissue or any other cellular-based structure. The acquisition rate is sufficiently rapid to make in vivo applications feasible. Measuring cellular morphology in tissues and in vitro as well as diagnosing intraepithelial neoplasia and assessing the efficacy of chemopreventive and chemotherapeutic agents are possible applications. Prospectively grading tissue samples without tissue processing is also possible, demonstrating the potential of the technique as a biomedical diagnostic.

In one embodiment, a “swept-source” (SS) light source is used in LCI to obtain structural and depth information about a sample. The swept-source light source is used to generate a reference signal and a signal directed towards a sample. Light scattered from the sample is returned as a result and mixed with the reference signal to achieve interference and thus provide structural and depth-resolved information regarding the sample. With a “swept-source,” the light source is controlled or varied to sweep the center wavelength of a narrow band of emitted light over a given range of wavelengths, thus synthesizing a broad band source. Because the light is emitted in particular wavelengths or narrower ranges of wavelengths during emission, scattered light returned from the sample is known to be in response to a particular wavelength or range of wavelengths. Thus, the returned scattered light is spectrally-resolved and depth-resolved, because the returned light is in response to the light source emitted light over a narrow spectral range. This is opposed to a wider or broadband light source that generates all wavelengths of light in one light emission in time, wherein the returned scattered light from the sample contains scattered light at a broad range of wavelengths. In this instance, a spectrometer is used to spectrally-resolve the returned scattered light. However, when using a swept-source light source, the series of returned scattered lights from the sample at each wavelength are already in the spectral domain to provide spectrally-resolved information about the sample. The spectrally-resolved information about the sample can be detected.

Another embodiment involves using a swept-source light source in angle-resolved low-coherence interferometry (a/LCI), referred to herein as “swept-source Fourier domain a/LCI,” or “SS a/LCI.” The data acquisition time for SS a/LCI can be less than one second, a threshold which is desirable for acquiring data from in vivo tissues. The swept-source light source is employed to generate a reference signal and a signal directed towards a sample over the swept range of wavelengths or ranges of wavelengths. The light is either directed to strike the sample at an angle, or the light source or another component in the system (e.g., a lens) is moved to direct light onto the sample at an angle or plurality of angles (i.e. two or more angles), which may include a multitude of angles (i.e. more than two angles). This causes a set of scattered light to be returned from the sample at a plurality of angles, thereby representing spectrally-resolved and angle-resolved (also referred to herein as “spectral and angle-resolved”) scattered information about the sample from a plurality of points on the sample. The spectral and angle-resolved scattered information about the sample can be detected. This SS a/LCI embodiment can also use the Fourier domain concept to acquire depth-resolved information. It has recently been shown that improvements in signal-to-noise ratio, and commensurate reductions in data acquisition time are possible by recording the depth scan in the Fourier (or spectral) domain. In this embodiment, the SS a/LCI system can combine the Fourier domain concept with the use of a swept-source light source, such as a swept-source laser, and a detector, such as a line scan array or camera, to record the angular distribution of returned scattered light from the sample in parallel and the frequency distribution in time.

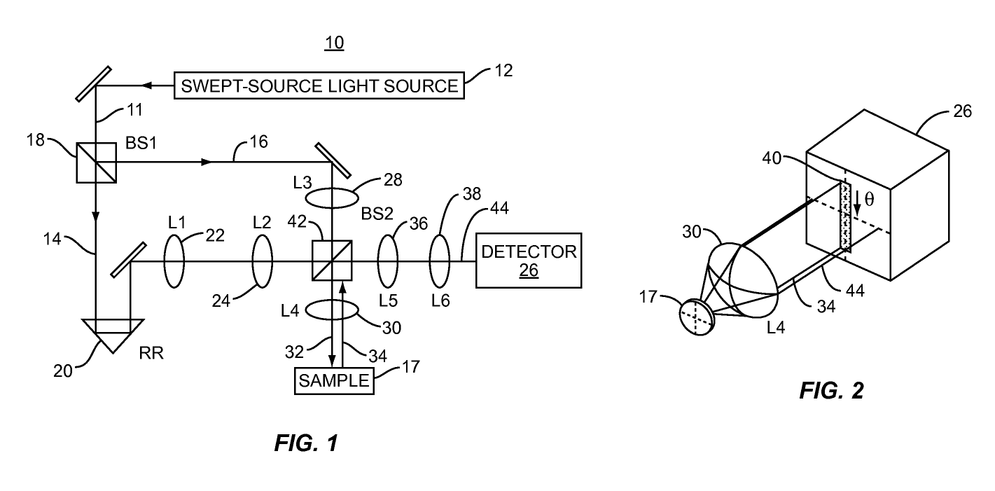

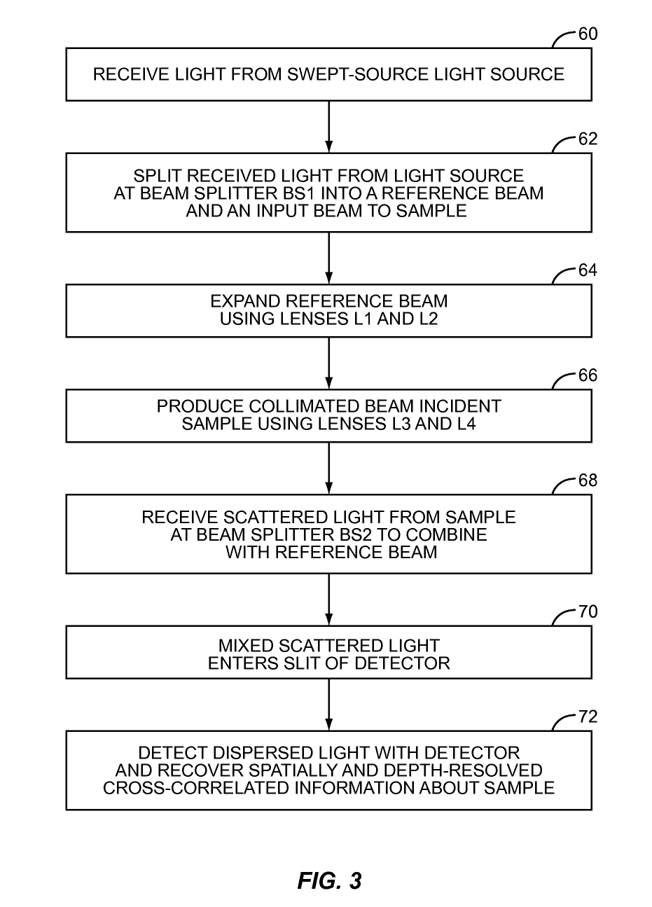

FIGS. 1 and 2 illustrate an example of an SS a/LCI system 10 according to one embodiment of the invention. The SS a/LCI apparatus and system in FIG. 1 may be based on a modified Mach-Zehnder interferometer. The discussion of the SS a/LCI system 10 in FIGS. 1 and 2 will be discussed in conjunction with the steps performed in the system 10 provided in the flowchart of FIG. 3. As illustrated in FIG. 1, light 11 from a swept-source light source 12 in the form of a swept-source laser 12 is generated. The light from the swept-source light source 12 is received (step 60, FIG. 3) split into a reference beam 14 and an input beam 16 to a sample 17 by beam splitter (BS1) 18 (step 62, FIG. 3). The path length of the reference beam 14 is set by adjusting retroreflector (RR) 20, but remains fixed during measurement. The reference beam 14 is expanded using lenses (L1) 22 and (L2) 24 (step 64, FIG. 3) to create illumination which is uniform and collimated upon reaching a detector device 26, which may be a line scan array or camera as examples.

Lenses (L3) 28 and (L4) 30 are arranged to produce a collimated pencil beam 32 incident on the sample 17 (step 66, FIG. 3). By displacing lens (L4) 30 vertically relative to lens (L3) 28, the input beam 32 is made to strike the sample 17 at an angle relative to the optical axis. In this embodiment, the input beam 32 strikes the sample 30 at an angle of approximately 0.10 radians; however, the invention is not limited to any particular angle. This arrangement allows the full angular aperture of lens (L4) 30 to be used to collect returned scattered light 34 from the sample 17.

The light scattered by the sample 17 is collected by lens (L4) 30 (step 68, FIG. 3) and relayed by a 4f imaging system, via lenses (L5) 36 and (L6) 38, such that the Fourier plane of lens (L4) 30 is reproduced in phase and amplitude at a slit 40, as illustrated in FIG. 2 (step 70, FIG. 3). The scattered light 34 is mixed with the reference beam 14 at beam splitter (BS2) 42 with combined beams 44 falling upon the detector device 26. The combined beams 44 are processed to recover depth-resolved spatial cross-correlated information about the sample 17 (step 72, FIG. 3).

In this embodiment, the detector device 26 is a one-dimensional detection device in the form of a line scan array, which is comprised of a plurality of detectors. This allows the detector device 26 to receive light at the plurality of scatterer angles from the sample 17 and mixed with the reference beam 14 at the same time or essentially the same time to receive spectral information about the sample 17. Providing the line scan array 26 allows detection of the angular distribution of the combined beams 44, or said another way, at multiple scatter angles. Each detector in the detector device 26 receives scattered light from the sample 17 at a given angle at the same time or essentially the same time.

Because the emitted light from the swept-source light source 12 is broken up into particular wavelengths or narrower ranges of wavelengths during emission, returned scattered light 34 from the sample 17 is known to be in response to a particular wavelength or range of wavelengths. Thus, the returned scattered light 34 is spectrally-resolved, because the returned scattered light 34 is in response to the light source emitted light over a spectral domain. This is opposed to a wider or broadband light source that generates all wavelengths of light in one light emission at the same time, wherein the returned scattered light from the sample contains scattered light at all wavelengths. In this instance, a spectrometer is used to spectrally-resolve the returned scattered light. However, when using the swept-source light source 12, the series of returned scattered light 34 from the sample 17 at each wavelength is already in the spectral domain to provide spectrally-resolved information about the sample.

FIG. 2 illustrates an example of the distribution of scattering angles across the dimension of the front of a line scan array 26. The combined beams or detected signal 44 detected by the detector device 26 is a function of vertical position on the line scan array, y, and wavelength λ, which is a function of time as the swept-source light source 12 is swept across its wavelength range. The detected signal 44 at pixel m and time t can be related to the scattered light 34 and reference beam 14 (Eₛ, Eᵣ) as:

I(λₘ,yₙ)= [symbol] |Eᵣ(λₘ,yₙ)|² [symbol] + [symbol] |Eₛ(λₘ,yₙ)|² [symbol] +2Re [symbol] Eₛ(λₘ,yₙ)Eᵣ*(λₘ,yₙ) [symbol] cos φ, (1)

where Φ is the phase difference between the two fields and [symbol] . . . [symbol] denotes an ensemble average in time. The interference term is extracted by measuring the intensity of the scattered light 34 and reference beam 14 independently and subtracting them from the total intensity. In one method of obtaining depth-resolved information about the sample 17, the wavelength spectrum at each scattering angle is interpolated into a wavenumber (k=2π/λ) spectrum and Fourier transformed to give a spatial cross correlation, Γ_{SR}(z) for each vertical pixel yₙ:

Γ_{SR}(z,yₙ)=∫dke^{ikz} [symbol] Eₛ(k,yₙ)Eᵣ*(k,yₙ) [symbol] cos φ. (2)

The reference field takes the form:

Eᵣ(k)=Eₒexp[−((k−kₒ)/Δk)²]exp[−((y−yₒ)/Δy)²]exp[ikΔl] (3)

where k_{O} (y_{O} and Δk (Δy) represent the center and width of the Gaussian wavevector (spatial) distribution and Δl is the selected path length difference. The scattered sample field takes the form

Eₛ(k,θ)=ΣⱼEₒexp[−((k−kₒ)/Δk)²]exp[iklⱼ]Sⱼ(k,θ) (4)

where Sⱼ represents the amplitude distribution of the scattering originating from the jth interface, located at depth lⱼ. The angular distribution of the scattered sample field is converted into a position distribution in the Fourier image plane of lens (L4) 30 through the relationship y=f₄ θ. For the exemplary pixel size of the line scan array 26 of eight (8) to twelve (12) micrometers (μm), this yields an angular resolution of 0.00028 to 0.00034 mradians and an expected angular range of 286 to 430 mradians for a 1024 element array. Inserting Eqs. (3) and (4) into Eq. (2) and noting the uniformity of the reference field (Δy>>camera height) yields the spatial cross correlation at the nth vertical position on the detector:

$${Γ}_{SR} ( z , {y}_{n} ) = {\sum }_{j}^{ } {\int }_{ }^{ } d k {\vert {E}_{o} \vert}^{2} exp [ - 2 {( ( k - {k}_{o} ) / Δ k )}^{2} ] exp [ i k ( z - Δ l + {l}_{j} ) ] \times {S}_{j} ( k , {θ}_{n} = {y}_{n} / {f}_{4} ) cos φ \qquad ( 5 )$$

Evaluating this equation for a single interface yields:

Γ_{SR}(z,yₙ)=|Eₒ|²exp[−((z−Δl+lⱼ)Δk)²/8]Sⱼ(kₒ,θₙ=yₙ/f₄)cos φ. (6)

Here, it is assumed that the scattering amplitude S does not vary appreciably over the bandwidth of the source. This expression shows obtaining a depth-resolved profile of the scattering distribution with each vertical pixel corresponding to a scattering angle. The techniques described in U.S. patent application Ser. No. 11/548,468 entitled “Systems and Methods for Endoscopic Angle-Resolved Low Coherence Interferometry,” which is incorporated herein by reference in its entirety, may be used for obtaining structural and depth-resolved information regarding scattered light from a sample.

To obtain the same or similar data set as is obtained from a single frame capture from an imaging spectrometer using a broadband light source, the SS a/LCI apparatus and system 10 can capture a series of data acquisitions from the line scan array 26 at each wavelength and combine them. In this embodiment, the data acquisition rate of the line scan arrays 26 is less than the sweep rate of the swept-source light source 12. If one were to assume that 1000 wavelength (frequency) points are needed (and thus points in time for the swept-source), ten (10) to twenty (20) data acquisitions of scattered information from the sample 17 may be recovered per second using a line scan array. For example, this scenario could yield a time per acquisition of 50 to 100 milliseconds, which is satisfactory for clinical and commercial viability.

Line scan arrays and camera detector devices are widely available for both the visible and the near infrared wavelengths. Visible line scan arrays can operate from approximately ˜400 nm to ˜900 nm, for example, and may be based on silicon technology. Near infrared line scan arrays may operate from approximately ˜900 nm to ˜1700 nm or further. Table 1 below gives some typical specification from several manufacturers as examples.

TABLE 1
Examples of Line Scan Arrays

| | λ range | Pixel | Pixel size | Readout rate |
|---|---|---|---|---|
| Manufacturer | (nm) | number | (μm) | (1000 lines/second) |
| Atmel | 400-950 | 512-4096 | 7-14 | 14 to 100 |
| Hamamatsu | 400-950 | 128-1024 | 25-50 | 2 to 20 |
| Fairchild | 400-850 | 2048 | 7 | 38 |
| Imaging | | | | |
| Hamamatsu | 900-1550 | 256-512 | 25-50 | 1 to 10 |
| Sensor's Unlimited | 900-1700 | 128-1024 | 25-50 | 4 to 20 |

As previously discussed above, a swept-source laser may be employed as the swept-source light source 12. Some examples are provided in Table 2 below.

TABLE 2
Examples of Swept-source Light Sources (Swept-source Lasers)

| | | | Sweep rate | Power |
|---|---|---|---|---|
| Manufacturer | Center λ nm | Δλ nm | (1000 sweeps/second) | (mW) |
| Thorlabs | 1325 | 150 | 17 | 12 |
| Micron | 1060, 1310, | 50, 110, | 8 | 5, 20, 20 |
| Optics | 1550 | 150 | | |
| Santec | 1310 | 110 | 20 | 3 |

Faster acquisition times are possible. Swept-source light sources at shorter wavelengths will allow use of a high speed detector 26, such as silicon detectors for example. For example, some Atmel® silicon-based cameras can achieve 100,000 lines per second, potentially allowing 100 data point acquisitions per second or 10 milliseconds per acquisition. Alternately, as another example, the line scan array 26 may be based on InGaAs technology and may be faster, reaching readout rates of 50,000 to 100,000 lines per second and thus reducing the acquisition time to 10 milliseconds. It is expected that the sweep rate, power, wavelength range, and other performance characteristics of the swept-source light sources can enable high performance versions of the a/LCI apparatuses and systems, including the SS a/LCI apparatus and system 10 of FIGS. 1 and 2.

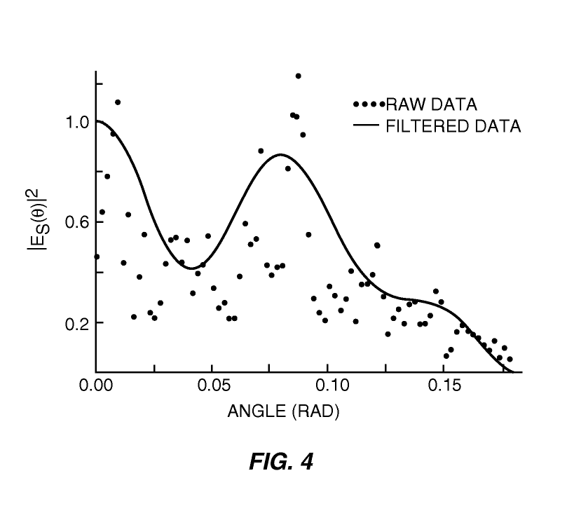

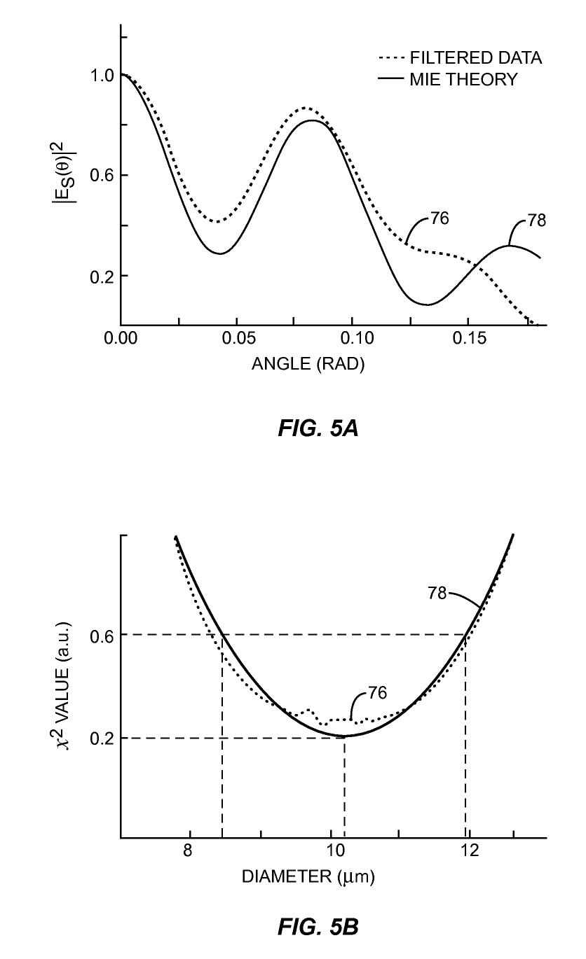

In addition to obtaining depth-resolved information about the sample 17, the scattering distribution data (i.e., a/LCI data) obtained from the sample 17 using the disclosed data acquisition scheme can also be used to make a size determination of the nucleus using the Mie theory. A scattering distribution of the sample 17 is illustrated in FIG. 4 as a contour plot. The raw scattered information about the sample 17 is shown as a function of the signal field 44 and angle. A filtered curve is determined using the scattered data. Comparison of the filtered scattering distribution curve (i.e., a representation of the scattered data) to the prediction of Mie theory (curve in FIG. 5A) enables a size determination to be made.

In order to fit the scattered data to Mie theory, the a/LCI signals are processed to extract the oscillatory component which is characteristic of the nucleus size. The smoothed data are fit to a low-order polynomial (2nd order is typically used but higher order polynomials, such as 4^{th} order, may also be used), which is then subtracted from the distribution to remove the background trend. The resulting oscillatory component can then be compared to a database of theoretical predictions obtained using Mie theory from which the slowly varying features were similarly removed for analysis.

A direct comparison between the filtered a/LCI data and Mie theory data 78 may not be possible, as the Chi-squared fitting algorithm tends to match the background slope rather than the characteristic oscillations. The calculated theoretical predictions include a Gaussian distribution of sizes characterized by a mean diameter (d) and standard deviation as well as a distribution of wavelengths, to accurately model the broad bandwidth source.

The best fit (FIG. 5A) can be determined by minimizing the Chi-squared between the data 76 and Mie theory (FIG. 5B), yielding a size of 10.2.+/−.1.7 μm, in excellent agreement with the true size. The measurement error is larger than the variance of the bead size, most likely due to the limited range of angles recorded in the measurement.

As an alternative to processing the a/LCI data and comparing to Mie theory, there are several other approaches which could yield diagnostic information. These include analyzing the angular data using a Fourier transform to identify periodic oscillations characteristic of cell nuclei. The periodic oscillations can be correlated with nuclear size and thus will possess diagnostic value. Another approach to analyzing a/LCI data is to compare the data to a database of angular scattering distributions generated with finite element method (FEM) or T-Matrix calculations. Such calculations offer superior analysis as they are not subject to the same limitations as Mie theory. For example, FEM or T-Matrix calculations can model non-spherical scatterers and scatterers with inclusions while Mie theory can only model homogenous spheres. Other techniques are described in U.S. Pat. No. 7,102,758 entitled “Fourier Domain Low-Coherence Interferometry for Light Scattering Spectroscopy Apparatus and Method,” which is incorporated herein by reference in its entirety.

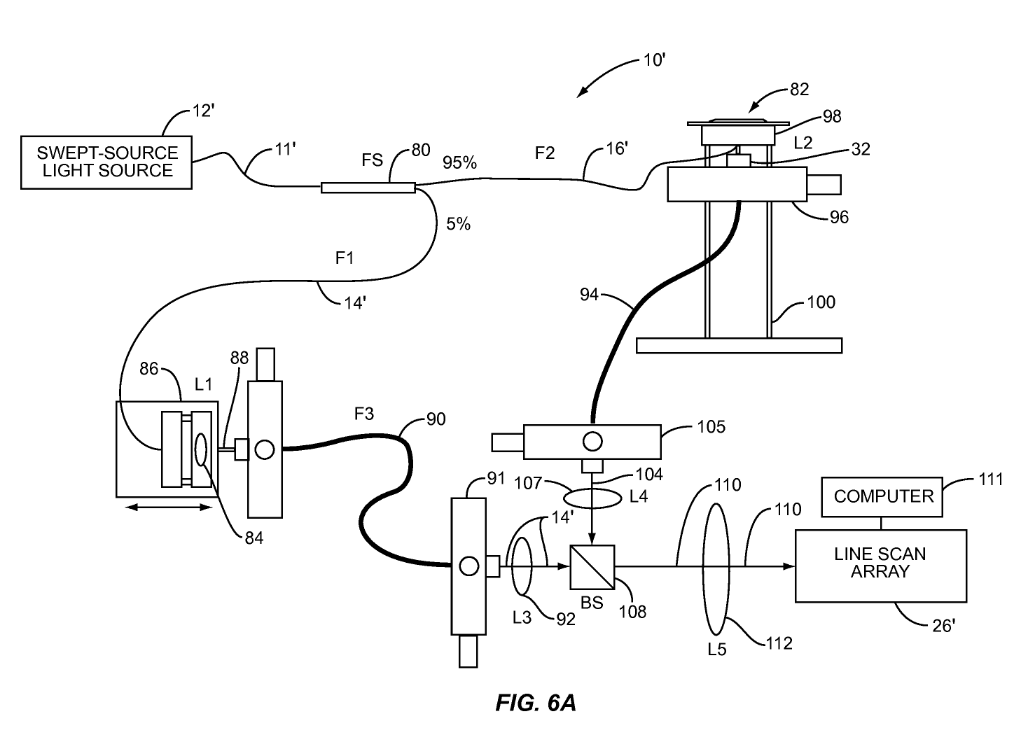

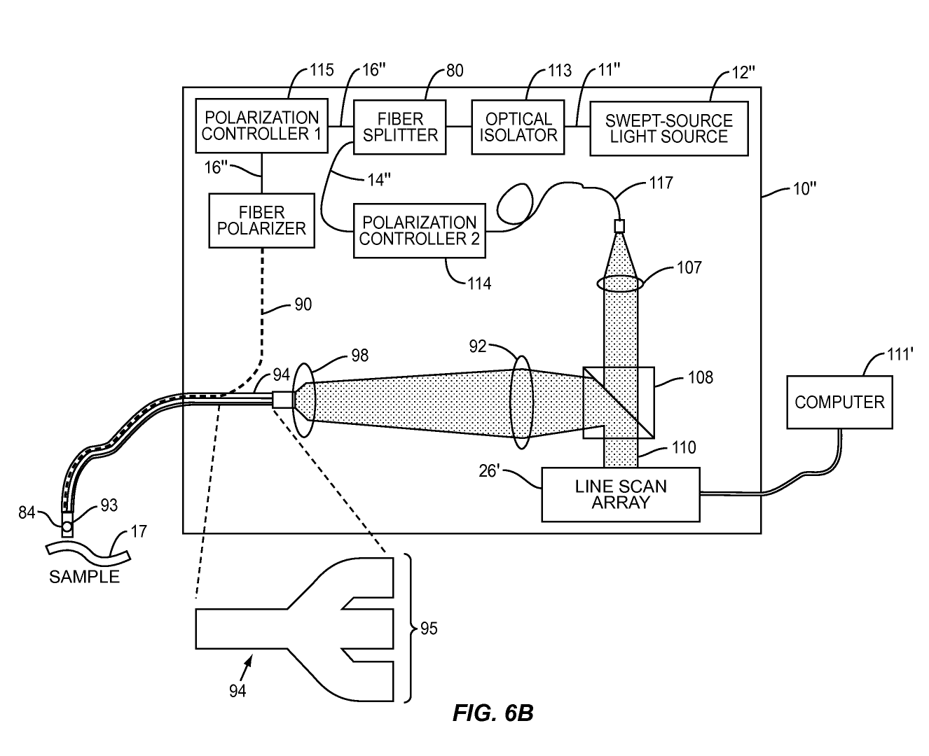

In another embodiment of the invention, an SS a/LCI apparatus and system can be provided, including for endoscopic applications, by using optical fibers to deliver and collect light from the sample of interest. These alternative embodiments are illustrated in FIGS. 6A and 6B. The fiber optic portion of the system is nearly identical, the system changes consist of a swept-source light source 12′ in place of the superluminescent diode, a line scan array (or camera) in place of the imaging spectrometer, and modification to the data processing to aggregate multiple acquisitions from the line scan array. The angular distribution of the returned scattered light from the sample is captured by locating the distal end of a fiber bundle in a conjugate Fourier transform plane of the sample using a collecting lens. This angular distribution is then conveyed to the distal end of the fiber bundle where it is imaged using a 4f system onto the line scan array. A beam splitter is used to overlap the scattered sample field with a reference field prior to the line scan array so that low-coherence interferometry can also be used to obtain depth-resolved measurements.

Turning now to FIG. 6A, a fiber optic SS a/LCI system 10′ is illustrated. A similar fiber optic SS a/LCI system 10′ is also illustrated in FIG. 6B. The fiber optic SS a/LCI system 10′ can make use of the Fourier transform properties of a lens. This property states that when an object is placed in the front focal plane of a lens, the image at the conjugate image plane is the Fourier transform of that object. The Fourier transform of a spatial distribution (object or image) is given by the distribution of spatial frequencies, which is the representation of the image's information content in terms of cycles per mm. In an optical image of elastically scattered light, the wavelength retains its fixed, original value and the spatial frequency representation is simply a scaled version of the angular distribution of scattered light.

In the fiber optic SS a/LCI system 10′, the angular distribution of scattered light from the sample is captured by locating the distal end of the fiber bundle in a conjugate Fourier transform plane of the sample using a collecting lens. This angular distribution is then conveyed to the distal end of the fiber bundle where it is imaged using a 4f system onto the line scan array. A beam splitter is used to overlap the scattered sample field with a reference field prior to the line scan array so that low-coherence interferometry can also be used to obtain depth resolved measurements.

Turning to FIG. 6A, light 11′ from a swept-source light source 12′ is split into a reference beam 14′ and an input beam 16′ using a fiber splitter (FS) 80. A splitter ratio of 20:1 may be chosen in one embodiment to direct more power to a sample (not shown) via a signal arm 82 as the returned scattered light 34′ from the sample is typically only a small fraction of the incident power. Light in the reference beam 14′ emerges from fiber (F1) and is collimated by lens (L1) 84 which is mounted on a translation stage 86 to allow gross alignment of the reference arm path length. This path length is not scanned during operation but may be varied during alignment. A collimated beam 88 is arranged to be equal in dimension to the end 91 of fiber bundle (F3) 90 so that the collimated beam 88 illuminates all fibers in the fiber bundle (F3) 90 with equal intensity. The reference beam 14′ emerging from the distal tip of the fiber bundle (F3) 90 is collimated with lens (L3) 92 in order to overlap with the scattered sample field conveyed by fiber bundle (F4) 94 having a fiber breakout 95 to capture the returned scattered light form the sample 17 at a plurality of angles at the same time. In an alternative embodiment, light emerging from fiber (F1) is collimated then expanded using a lens system to produce a broad beam.

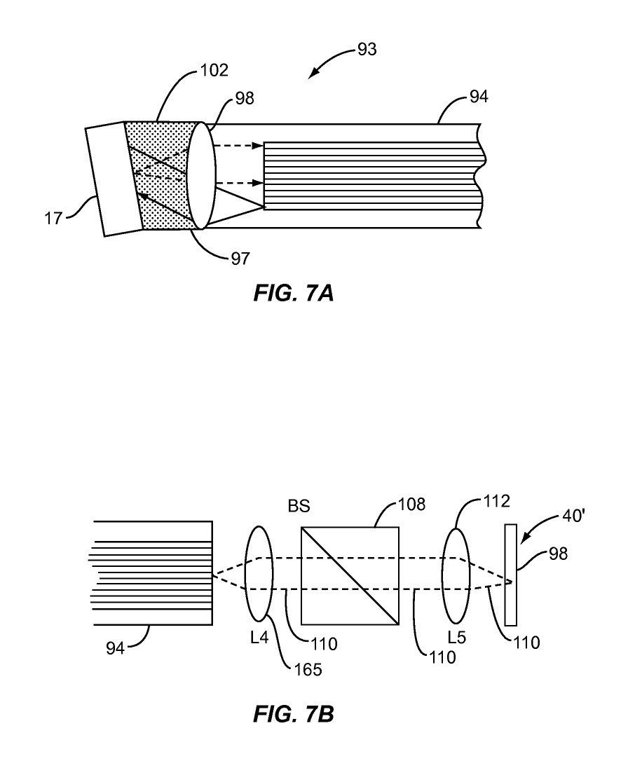

The scattered sample field is detected using a coherent fiber bundle. The scattered sample field is generated using light in the signal arm 82 which is directed toward the sample of interest using lens (L2) 98. As with the free space system, lens (L2) 98 is displaced laterally from the center of single-mode fiber (F2) such that a collimated beam is produced which is traveling at an angle relative to the optical axis. The fact that the incident beam strikes the sample at an oblique angle is essential in separating the elastic scattering information from specular reflections. The scattered light 34′ is collected by a fiber bundle consisting of an array of coherent single mode or multi-mode fibers. The distal tip of the fiber is maintained one focal length away from lens (L2) 98 to image the angular distribution of scattered light. In the embodiment shown in FIG. 6A, the sample is located in the front focal plane of lens (L2) 98 using a mechanical mount 100. In the endoscope compatible probe 93 shown in FIG. 7A, the sample is located in the front focal plane of lens (L2) 98 using a transparent sheath 102.

As illustrated in FIG. 6A and also in FIG. 7B, scattered light 104 emerging from a proximal end 105 of the fiber bundle (F4) 94 is recollimated by lens (L4) 107 and overlapped with the reference beam 14′ using beam splitter (BS) 108. The two combined beams 110 are re-imaged onto the line scan array 26′ using lens (L5) 112. The focal length of lens (L5) 112 may be varied to optimally fill the line scan array 26′. The line scan array 26′ passes the detected signal to a processing system, such as a computer 111, to process the return scattered signal to determine structural and depth-resolved information about the sample. The resulting optical signal contains information on each scattering angle across the vertical dimension of the slit 40′ as described above for the apparatus of FIGS. 1 and 2. It is expected that the above-described SS a/LCI system 12′, as an example, the fiber optic probe can collect the angular distribution over a 0.45 radian range (approximately 30 degrees) and can acquire the complete depth-resolved scattering distribution or combined beams 110 in a fraction of a second.

There are several possible schemes for creating the fiber probe which are the same from an optical engineering point of view. One possible implementation would be a linear array of single mode fibers in both the signal and reference arms. Alternatively, a reference arm 96 could be composed of an individual single mode fiber with the signal arm 82 consisting of either a coherent fiber bundle or linear fiber array.

The probe 93 can also have several implementations which are substantially equivalent. These would include the use of a drum or ball lens in place of lens (L2) 98. A side-viewing probe could be created using a combination of a lens and a minor or prism or through the use of a convex minor to replace the lens-minor combination. Finally, the entire probe can be made to rotate radially in order to provide a circumferential scan of the probed area.

Another exemplary embodiment of a fiber optic SS a/LCI system is the illustrated a/LCI system 10″ in FIG. 6B. In this system 10″, a swept-source light source 12″ is used just as in the fiber-optic a/LCI system 10′ of FIG. 6A. Other components provided in the system 10″ of FIG. 6B are also included in the system 10′ of FIG. 6A, which are indicated with common element designations. In the fiber optic SS a/LCI system 10″, the angular distribution of scattered light from the sample is captured by locating the distal end of the fiber bundle in a conjugate Fourier transform plane of the sample using a collecting lens. This angular distribution is then conveyed to the distal end of the fiber bundle where it is imaged using a 4f system onto the line scan array. A beam splitter is used to overlap the scattered sample field with a reference field prior to the line scan array so that low-coherence interferometry can also be used to obtain depth resolved measurements.

Turning to FIG. 6B, light 11″ is generated by a swept-source light source 12″. An optical isolator 113 protects the light source 12″ from back reflections. The fiber splitter 80 generates a reference beam 14″ and a sample beam 16″. The reference beam 14″ passes through an optional polarization controller 114, a length of fiber 117 (to path optical path lengths), and then to the lens (L4) 107 to the beam splitter 108. The sample beam 16″ travels through a polarization controller 115 and a fiber polarizer 116 to improve polarization of source light and align polarization with the axis of the fiber polarizer 116. The delivery or illumination fiber 90 is provided to the fiber probe 93. The lens 84 captures returned scattered light from the sample 17, which is collected at a particular angle (or a small range of angles) by the collection fiber bundle 94. Captured light is carried through the collection fiber bundle 94 comprised of a plurality of collection fibers 95. The captured light travels back up the fiber probe 93 through optical lens (L2) 98 and lens (L3) 92. The reference beam 14″ and returned scattered light from the sample 17 are mixed at the beam splitter 108 with the resulting interfering signal 110 being passed to a line scan array detector 26′ as previously described. The line scan array 26′ passes the detected signal to a processing system, such as the computer 111″, to process the return scattered signal to determine structural and depth-resolved information about the sample. The resulting optical signal contains information on each scattering angle across the vertical dimension of the slit 40′ as described above for the apparatus of FIGS. 1 and 2. It is expected that for one embodiment of the above-described SS a/LCI system 10″, as an example, the fiber optic probe 93 can collect the angular distribution over a 0.45 radian range (approximately 30 degrees) and can acquire the complete depth-resolved scattering distribution or combined beams 110 in a fraction of a second.

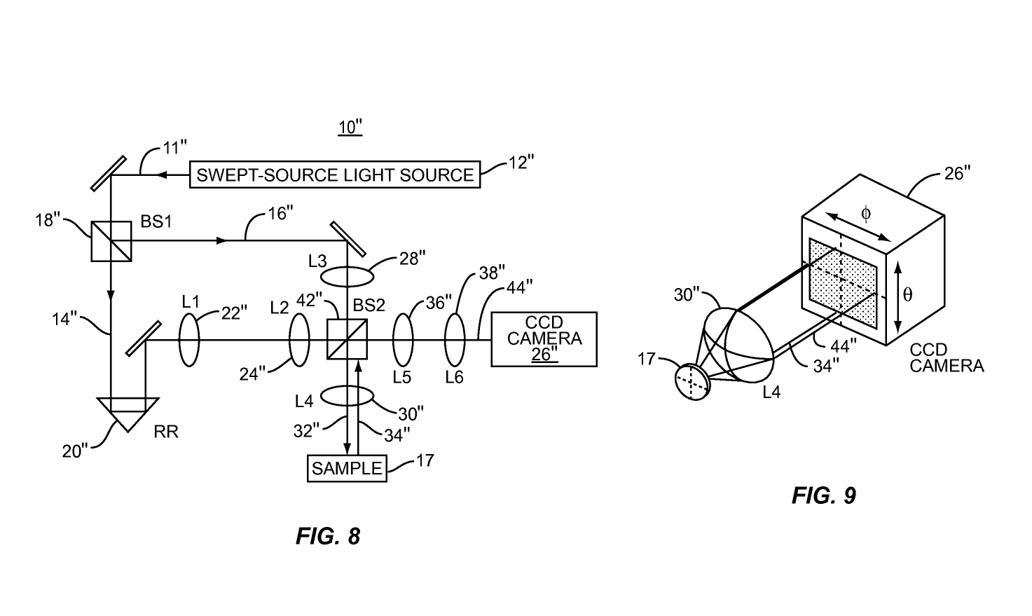

The use of a swept-source light source also opens up the possibility of another system architecture that has the capability to acquire scattering information from more than one scattering plane from a sample. This implementation is referred to as a “Multiple Angle Swept-source a/LCI” system or MA SS a/LCI. An example of an MA SS a/LCI system 10″ is illustrated in FIGS. 8 and 9, which has a similar arrangement to the SS a/LCI system 10 of FIGS. 1 and 2, except that a two-dimensional detection device 26″ is provided in the form of a CCD camera. This allows acquiring returned scatter information from a sample at multiple angles or range of angles at the same time or essentially at the same time. This arrangement allows one to obtain a larger amount of information with a single measurement compared to one-dimensional approaches. In a one-dimensional scheme, the scattering distribution is acquired across a single line of angles and requires sample manipulation to obtain information in another scattering plane. By acquiring information about the sample from multiple angles or a range of angles, it is possible to achieve better signal-to-noise in the resulting measurements and/or acquire more information about the sample such as the major and minor axis for non-spheriodal scatterers.

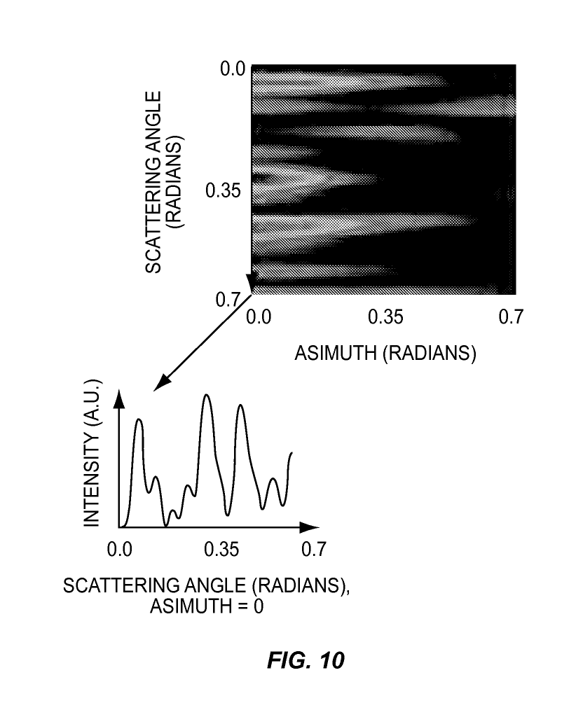

The MA SS a/LCI system 10″ is exemplified in FIG. 8 and is similar to the SS a/LCI of FIGS. 1 and 2, except that the line scan array 26 is replaced by a two-dimensional array 26″, such as a CCD camera. The steps set forth in the flowchart of FIG. 3 are applicable for this embodiment, except that this embodiment will involve the mixed returned scattered light being directed to a two-dimensional detector 26″ (step 70) and detecting dispersed light to recover spatially and depth-resolved information about the sample using the two-dimensional detector 26″ (step 72). Further, the MA SS a/LCI system 10″ can be implemented using a fiber optic probe and bundle detection system like that of FIG. 6B, except that the line scan array 26′ is replaced by a two-dimensional detector 26″, namely a CCD camera. In either implementation example, the CCD camera 26″may acquire a frame at each step as the swept-source light source 12″, such as a swept-source laser, is swept (or more likely may capture a frame as the light source sweeps continuously resulting in a range of wavelengths captured in each frame). The swept-source light source 12″ sweeps over frequencies as the CCD camera 26″ synchronously captures images from the combined beams 44″ from the sample 17. With this method, the acquisition time may decrease to a fraction of a second. The collection of frames from a sweep of the swept-source light source 12″ will then be processed to generate wavelength information for either a range of scattering angles in the θ and φ direction, a set of discrete angles, or some combination of the two. Further processing will provide information about the nature of the scatterers in the sample 17. FIG. 10 illustrates an exemplary model of a two-dimensional image of a diffraction pattern due to eight micron spheroid distribution using the MA SS a/LCI of FIG. 8.

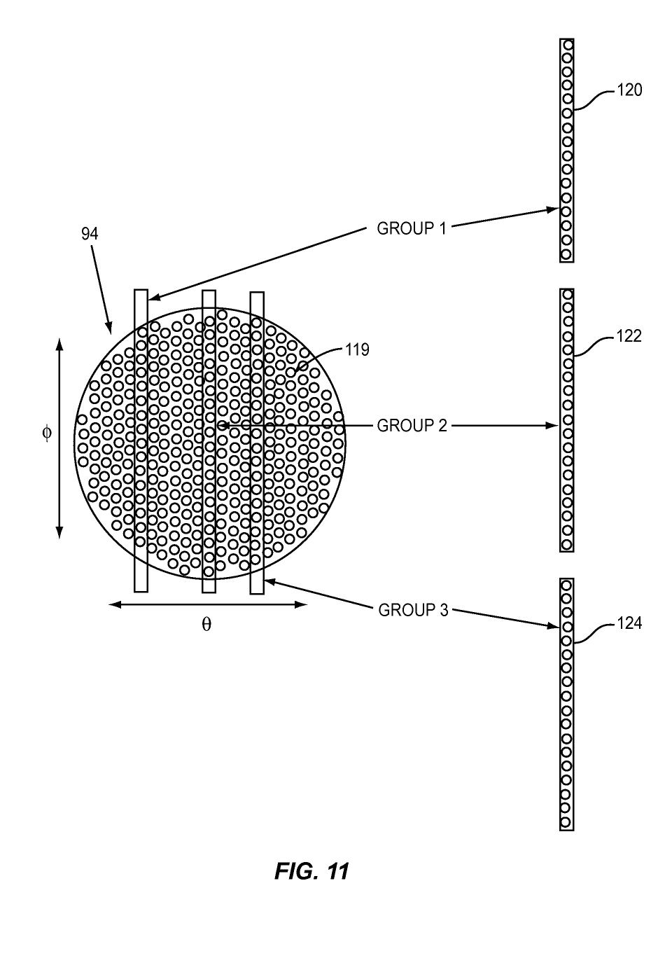

The MA SS a/LCI system 10″ may also be implemented using a broadband light source, such as a superluminescent diode (SLD), and using a spectrometer detection device. In either case, whether using a broadband light source or swept-source light source 12″, in the fiber optic embodiment of a MA SS a/LCI system 10″, the fiber bundle 94 that receives the combined beams 44″ from the sample 17 can be captured by a plurality of optical fibers 119 in the fiber bundle 94, as illustrated in FIG. 11. Here, the optical fiber breakout is issued to bring optical fibers 119 from the fiber bundle 94 to one or more horizontal lines 120, 122, 124, but radial and circular breakouts are also possible, which are different types of sections of the optical fibers 119. The number of optical fibers 119 shown in a vertical row is one optical fiber 119 wide, but any number is possible. The number of optical fibers 119 used horizontally at a given position in the vertical column will determine the angular range of the particular reading from a detection device 26″ or spectrometer, as the case may be.

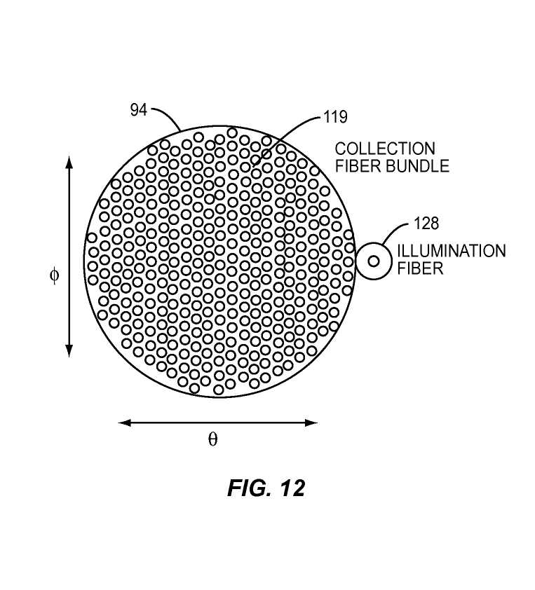

One possible distribution of the scattering angles across the CCD camera 26″ is shown in FIG. 12. In this implementation, angles in θ are spread vertically and angles in φ are spread horizontally. The angles may or may not be distributed evenly in θ and φ. For example, in the endoscopic implementation described later in this application, an illumination fiber 128 lies on one side of a fiber bundle and the angles acquired will be determined by the locations of the fibers in the bundle. This is shown in FIG. 12, where the system 10″ will be able to collect some subset of the angles in θ and φ, but even here there may be enough additional information acquired that additional structural measurements can be generated by the data processing.

Potential components for the CCD camera 26″ include but are not limited to a Cascade:Photometrics™ 650 CCD camera as the image detector. For the light source, the Thorlabs INTUN™ continuously tunable laser is an example of one of many suitable sources. This example would be useful because the center wavelength is 780 nm, which is compatible with standard NIR optical elements, including the Cascade camera, and offers a tuning range of 15 nm, which is comparable to the line width used in SS a/LCI systems previously described. The tuning speed of 30 nm/s for this source is optimal for synchronization with the Cascade CCD camera as better than 0.1 nm resolution can be achieved based on the 300 Hz frame rate which can be realized when using a region of interest with the Cascade CCD. The SS a/LCI scheme will improve acquisition time and upgrade the a/LCI system to a state-of-the-art technology for studies of cell mechanics at faster time scales.

The data acquisition may be limited by the frame rate of the CCD camera 26″ and not by the sweep speed of the swept-source light source 12″. Table 3 below lists exemplary CCD cameras. The fastest listed is only 1000 frames per second, so if 1000 wavelength points are required, a full scan will take approximately 1 second. It may be possible to scan faster if fewer pixels are needed in this example, or if fewer points in wavelength can be used. Several of these cameras will let the user target specific regions of interest to acquire images, thus speeding up the frame rate. For example, with the Atmel® camera, if one uses a region of interest that is 100×100 pixels for a total of 10000 pixels, then the frame rate might be as high at 15,000 frames per second allowing a scan time of 70 milliseconds for 1000 wavelength points. It is expected that the speed of the CCD cameras will increase over time and the increased camera speed will translate into higher performance of the MA SS a/LCI system.

TABLE 3
Examples of High Speed CCD Cameras

| | λ range | | Pixel size | Readout rate |
|---|---|---|---|---|
| Manufacturer | (nm) | Pixel number | (μm) | (1000 pixels/second) |
| Atmel | 400-900 | 2000 × 1000 | 5 | 150000 |
| Hamamatsu | 400-950 | 250 × 1024 | 25 | 10000 |
| Fairchild | 400-850 | 512 × 512 | 17 | Up to 1000 |
| Imaging | | | | frame/sec |

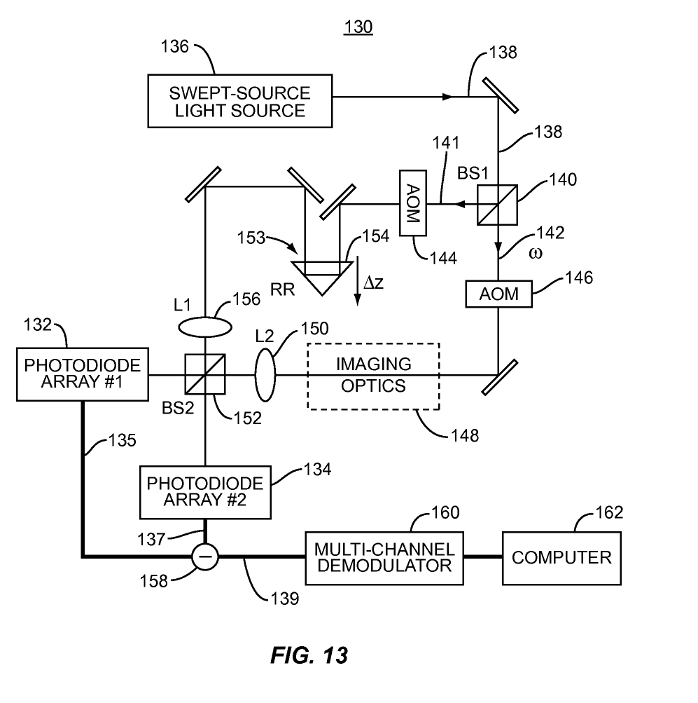

In addition to the SS a/LCI and MA SS a/LCI implementations described herein, a time-domain a/LCI implementation is also possible. An example of this a/LCI system 130 implementation is shown by example in FIG. 13. This system 130 physically scans the depth of a sample, but uses an array of detectors to simultaneously collect returned scattered light from the sample from multiple angles at the same time or essentially the same time. This allows the system 130 to simultaneously collect light from multiple angles increasing throughput by a factor equal to the number of angle acquisitions.

The system 130 uses photodiode arrays #1 and #2 132, 134 to collect angular scattered light from the sample (not shown). The system 130 provides a swept-source light source 136 in the form of a Ti:Sapphire laser operating in a pulsed mode in this embodiment. The swept-source light source 136 directs light 138 to a beam splitter (BS1) 140, which splits the light 138 into a reference signal 141 and sample signal 142. The reference signal 141 goes through acousto optic modulator (AOM) 144 with w+10 MHz, and then through retroreflector (RR) 154 mounted on a reference arm 153, wherein the retroreflector (RR) 154 is moved by a distance, δz to change the depth in the sample to perform depth scans. The sample signal 142 goes through AOM 146 with frequency ‘ω’ and then through imaging optics 148. Imaging optics 148 shine collimated light onto the sample and then collect the angular scattered light from the sample. The reference signal 141 and the angular scattered light are combined at beamsplitter (BS2) 152 and then imaged onto the photodiode arrays #1 and #2 132, 134. Signals 135, 137 from each photodiode 132 or 134 are subtracted from the photodiode in the other array 132 or 134 which corresponds to the same angular location. A multi-channel demodulator 160 is used on the subtracted signal 139. All signals then go to a computer 162 for processing. Processing of the time-domain depth information from the subtracted signal 139 and received by the multi-channel demodulator 160 can be performed just as previously described in above in paragraphs 0055 through 0058 for this embodiment, as possible examples or methods.

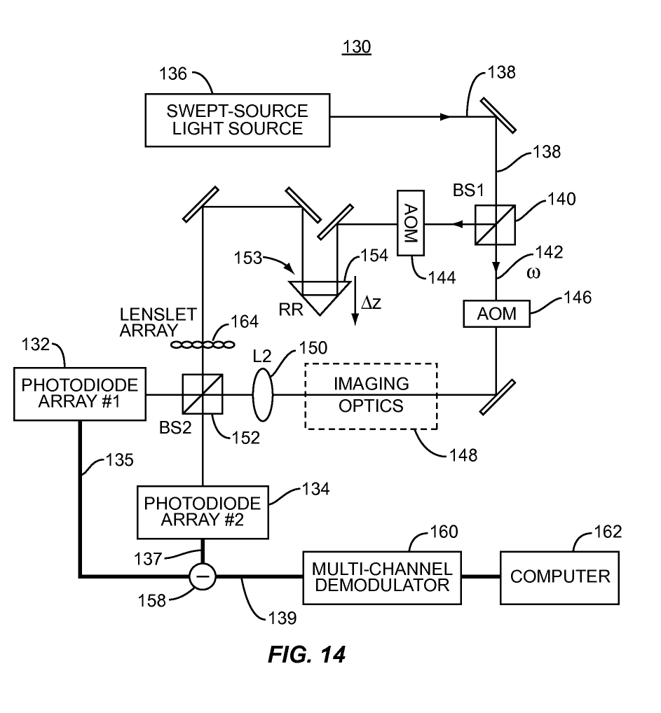

FIG. 14 illustrates the same system 130 of FIG. 13, except that lens L1 156 is changed out for lenslet array 164. Each lenslet in the lenslet array 164 provides the reference arm 153 for one angular position. A lenslet array can be used for each angular position in the photodiode arrays 132, 134 to properly capture angular scattered light from the sample.

For the embodiments illustrated in FIGS. 13 and 14, in a typical setup, data about the sample may be acquired at 20 to 60 angles and takes approximately 6 minutes for a 60 angle scan. This implementation should be able to acquire this same data set in at least six (6) seconds. While still possibly slower than Fourier domain techniques (due to the higher intrinsic signal-to-noise ratio available in the Fourier domain systems), this can be an improvement in speed and be used for many applications. This implementation calls for photodiode arrays that can acquire enough line scans, such that there are up to 500 in a depth scan. If a scan takes 6 seconds, this is approximately 100 per second, which is much less than the line rates of any of the cameras listed in Table 1. Given that cameras can capture frames much faster than this, the limit to acquisition speed may be the amount of available light scattered from the sample.

Note that this system uses some means of subtracting the signals 135, 137 on the photodiodes 132, 134 by photodiode basis and then demodulating each channel. This may be accomplished in a serial or parallel fashion. One implementation would be to digitally acquire data from the photodiode arrays (as in the case of a line scan camera) and then use a digital signal processor (DSP) chip or similar to subtract and demodulate the data. This may require that the offset frequency between the two AOMs be less than the line rate of the line scan arrays. Since line scan arrays exist that receive signal data up to 100,000 lines/second, an offset of <50 KHz may be acceptable.

A second implementation would be to use the photodiode arrays 132, 134 and perform the subtraction in an analog basis. It may be the case that the two photodiode arrays are actually two sections of the same two-dimensional array. There also may then be a dedicated demodulator for each photodiode pair or, again, a digitizer and appropriate digital signal processor (DSP) chips.

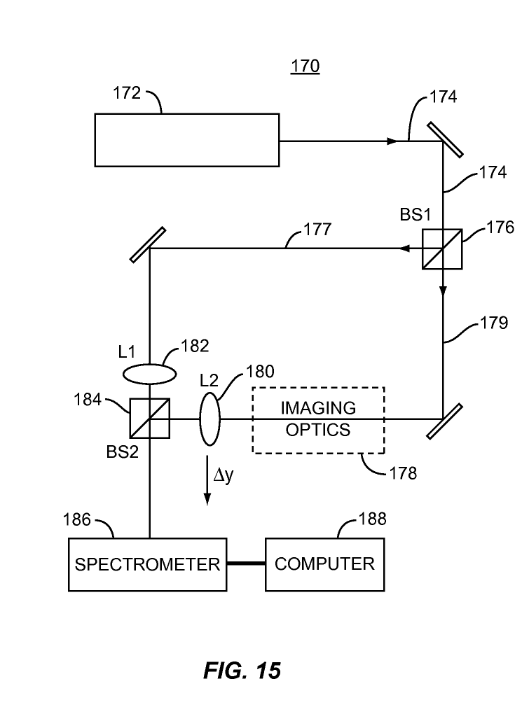

In another embodiment and approach to collecting information about a sample of interest, a step forward from time domain a/LCI systems is taken to still collect the angular information in a serial fashion. However, depth information is collected from a sample of interest using a Fourier domain approach. The light source that may be used can include a broadband light source in combination with a spectrometer to process spectrally-resolved information about the sample. Alternatively, a swept-source light source with a photodiode or another implementation may be used. FIG. 15 shows an implementation of such a system 170. The system 170 illustrated employs a Ti:Sapphire pulsed laser light source 172 for a broadband light source with a single line spectrometer 186 in place of a photodiode for signal collection. In FIG. 15, the laser 172 in a pulsed mode generates light 174. Beam splitter (BS1) 176 splits the light 174 into a reference signal 177 and a sample signal 179. The reference signal 177 travels through optic(s), lens (L1) 182, while the sample signal 179 travels through imaging optics 178, which illuminate a sample (not shown) and capture scattered light returned from the sample. Lens (L2) 180 is moved to set the particular angle of scattered light from the sample that is being viewed by the spectrometer 186. Beamsplitter (BS2) 184 combines the reference signal 177 and the sample signal 179 which then travels to spectrometer 186. The combined signal then passes through computer 188 for processing. The spectrometer 186 captures at least one line of returned scattered light from the sample. The spectrometer 186 could capture more than one line (i.e., it could be an imaging spectrometer) to create a system that is closer to the current working implementation. This could be advantageous to either use a spectrometer with fewer lines, or allow capture of a larger angular range (or finer resolution).

Since this system 170 does not use a time domain data acquisition approach, the AOMs 144, 146 and the moving retroreflector (RR) 154 in the reference arm 153, as provided in the systems 130 in FIGS. 13 and 14, are not needed. This system 170 shows one spectrometer 186, but it is possible to use a second spectrometer on the other port of the beam splitter for additional signal for potential increases in optical signal-to-noise ratio (OSNR) or advanced processing or other reasons. This implementation has a significant OSNR advantage, on the order of the number of pixels covered by the broadband light source in the spectrometer 186. As noted, this system 170 can also be implemented with a swept-source light source in place of the Ti:Sapphire laser, and a single photodiode in place of the spectrometer 186.

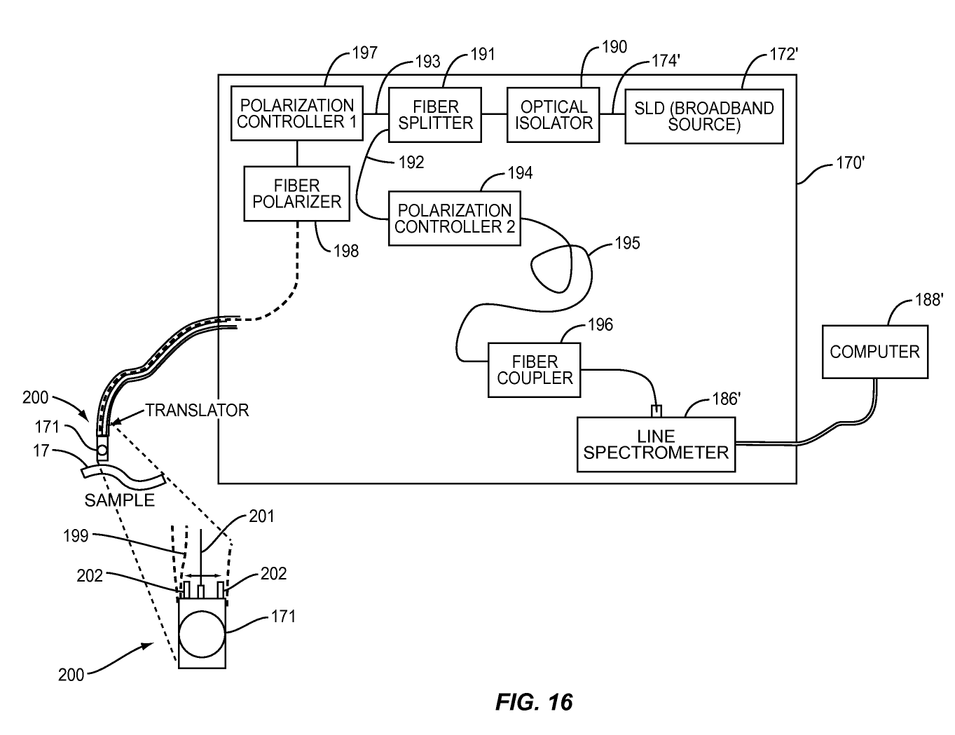

FIG. 16 illustrates another implementation of the Fourier domain system 170 of FIG. 15, with serial detection of angles, but using a fiber-optic approach. The angular information from the sample is collected serially by moving a fiber (or more than one fiber) back and forth in front of lens 171, which collects the returned angular scattered light from the sample 17. The optical engine is almost entirely fiber-optic in this particular implementation with the free space optics provided inside a line spectrometer 186′. This implementation is beneficial in terms of cost and ease of construction, since optical fibers are usually cheaper and easily to deal with than free space optical systems.

As illustrated in FIG. 16, light 174′ is generated by SLD broadband light source 172′. An optical isolator 190 protects the light source 172′ from back reflections. A fiber splitter 191 generates a sample signal 193 and a reference signal 192. The reference signal 192 passes through an optional polarization controller 194, a length of fiber 195 (to path optical path lengths), and then to a fiber coupler 196 (i.e., a fiber splitter used in opposite direction). The sample signal 193 travels through a polarization controller 197 and a fiber polarizer 198 to improve polarization of source light and align polarization with the axis of the fiber polarizer 198. An illumination fiber 199 is provided to a fiber probe 200 and passes through lens 171 to illuminate the illumination fiber 199. Lens 171 captures returned scattered light from the sample 17, which is collected at a particular angle (or at a small range of angles) by a collection fiber 201. The collection fiber 201 is moved to capture information from different angles from the sample 17. A motion mechanism shown is based on electromagnets 202 in this embodiment. Any method to move the collection fiber 201 with respect to the sample 17 can be used. The collection fiber 201 can be moved in one dimension or in multiple dimensions. Light from the collection fiber 201 travels back up the fiber probe 200 and into an optical engine (not shown) where it connects to the fiber coupler 196. The reference signal 193 and returned scattered light from the sample 17 are mixed at the fiber coupler 196 with the resulting light signal passed to the line spectrometer 186′. The combined signal then passes through computer 188 for processing. Again, this embodiment is illustrated with one collection fiber, but it could be implemented with multiple collection fibers that are moved to either reduce the needed size of the spectrometer or increase the angular range.

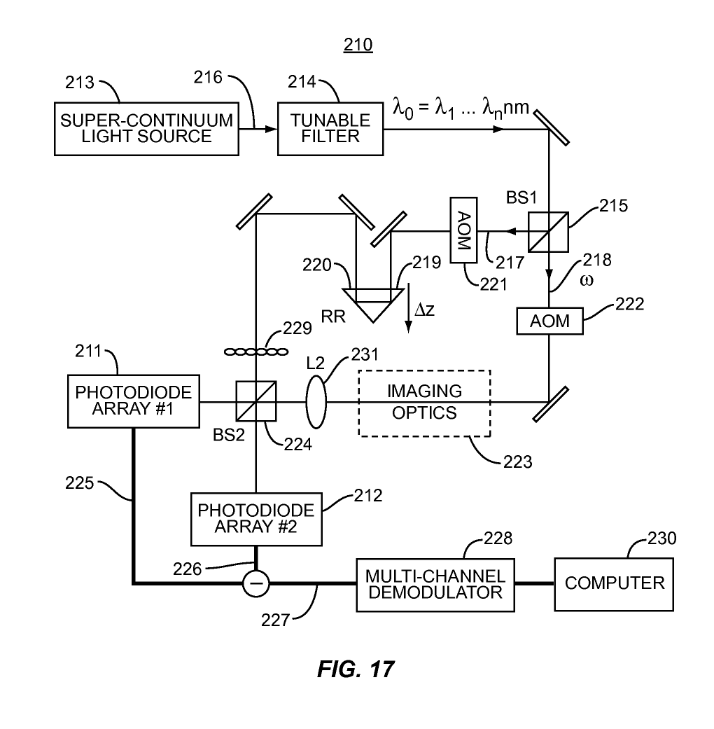

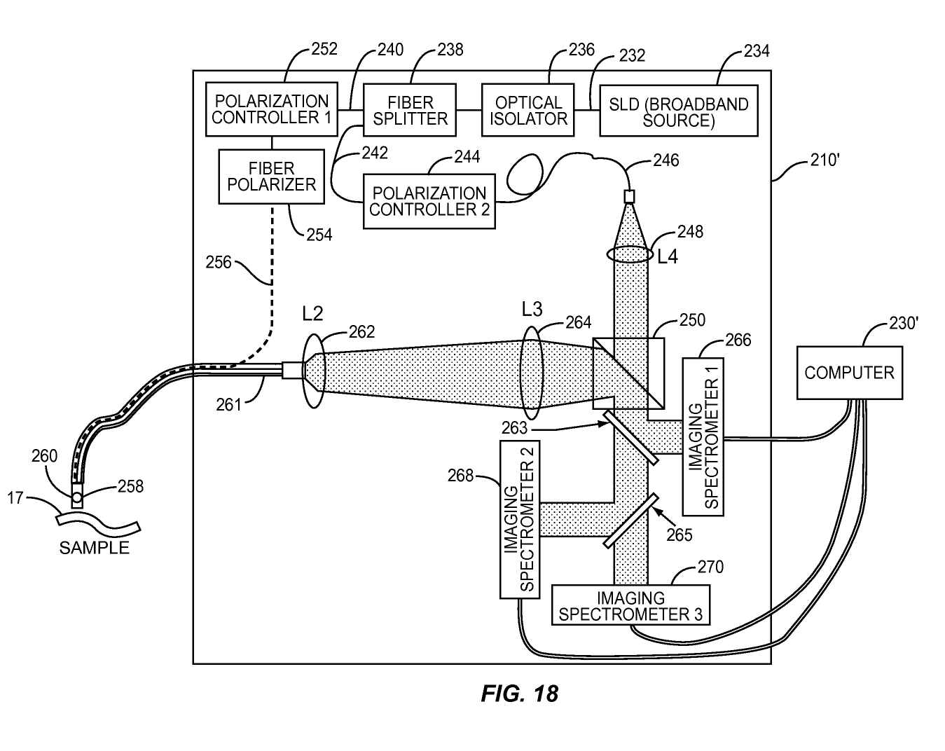

Another implementation of a/LCI is a multi-spectral a/LCI system. Embodiments of multi-spectral a/LCI systems 210, 210′ are illustrated in FIGS. 17 and 18. In this approach, a/LCI measurements are performed at multiple wavelengths (or frequencies) that may be separated, such as by a few up to hundreds of nanometers. The system 210 responds like an f/LCI system, where depth information regarding a sample of interest is obtained at multiple wavelengths. Multi-spectral a/LCI can obtain both depth and angular information at multiple wavelengths. This system 210 can thereafter generate the structural and depth information using techniques that utilize a/LCI or f/LCI. Alternatively, the system 210 can be used to measure tissue responses at a few wavelengths to determine properties of blood, water or other characteristics of the tissue.

The system 210 of FIG. 17 uses time domain for obtaining depth information and involves parallel acquisition of angular information and a tunable source for multi-spectral information acquisition. The system 210 uses photodiode arrays #1 and #2 211, 212 to collect angular scattered light from the sample (not shown). The system 210 provides a super-continuum light source 213 with a tunable filter 214 that provides a 10 to 20 nm spectral bandwidth and that can be tuned over a few up to hundreds of nanometers in this example. A commercially available example of this light source is the SC450-AOTF from Fianium®, which combines a fiber-optic super-continuum light source with an acousto-optic tunable filter. Other source examples could include white light sources, such as Xenon lamps as an example. Other filters may be used, including but not limited to liquid crystal (LC) optical filters.

The super-continuum light source 213 directs light 212 to a beam splitter (BS1) 215, which splits the light 216 into a reference signal 217 and sample signal 218. The reference signal 217 goes through AOM 221, and then through retroreflector (RR) 219 mounted on a reference arm 220, wherein the retroreflector (RR) 219 is moved by the reference arm 220 to change the depth in the sample to perform depth scans. The sample signal 218 goes through AOM 222 with frequency ‘ω’ and then through imaging optics 223. Imaging optics 223 shine light from the super-continuum light source 213 onto a sample and then collects the angular scattered light from the sample. The reference signal 217 and the angular scattered light are combined at beamsplitter (BS2) 224 and then imaged onto the photodiode arrays #1 and #2 211, 212. Signals 225, 226 from each photodiode 211 or 212 are subtracted from the photodiode in the other array 211 or 212 which corresponds to the same angular location. A multi-channel demodulator 228 is used on the resulting subtracted signal 227. The subtracted signal 227 travels to a computer 230 for processing.

Another approach to the multi-spectral a/LCI system 210 in FIG. 17 is to use a broadband light source with multiple spectrometers. An example of one such system 210′ is illustrated in FIG. 18. The system 210′ uses Fourier domain for obtaining depth information about a sample, and parallel acquisition of angular information and parallel acquisition of multi-spectral information by use of broadband filters and multiple spectrometers. The optical engine is almost entirely fiber-optic in this particular implementation with the free space optics provided inside imaging spectrometers 266, 268, 270. This implementation is beneficial in terms of cost and ease of construction, since optical fibers are usually cheaper and easily to deal with than free space optical systems.

As illustrated in FIG. 18, light 232 is generated by a SLD broadband light source 234. An optical isolator 236 protects the light source 234 from back reflections. A fiber splitter 238 generates a sample signal 240 and a reference signal 242. The reference signal 242 passes through an optional polarization controller 244, a length of fiber 246 (to path optical path lengths), and then to a lens (L4) 248 to a beamsplitter 250. The sample signal 240 travels through a polarization controller 252 and a fiber polarizer 254 to improve polarization of source light and align polarization with the axis of the fiber polarizer 254. An illumination fiber 256 is provided to a fiber probe 258 and passes through lens 260 to illuminate the illumination fiber 256. The lens 260 captures returned scattered light from the sample 17, which is collected at a particular angle (or a small range of angles) by a collection fiber 261. Captured light carried through the collection fiber 261 travels back up the fiber probe 258 through optical lens (L2) 262 and lens (L3) 264. The reference signal 242 and returned scattered light from the sample 17 are mixed at beamsplitter 250. Two free space optical filters 263, 265 split the scattered light spectrum from the sample into three light signals, each being provided to a separate imaging spectrometer 266, 268, 270. This allows the spectrally-resolved scattered light from the sample 17 to be processed by computer 230′ using Fourier domain techniques to obtain structural and depth information about the sample.

It is possible to provide this system 210′ with one spectrometer, although the combination of multiple spectrometers allows for high spectral resolution for the Fourier domain depth detection and the broad range of wavelengths needed to acquire the multi-spectral information. The system 210′ can be expanded to as many sections of the optical spectrum as needed. Fiber implementations based on fiber couplers and fiber filters are also possible.

The system 210′ may also be provided with a broadband swept-source light source for the acquisition of depth information and the acquisition of multi-spectral information. Another approach is to multiplex together multiple sources at different wavelengths to obtain the multi-spectral information. For example, an 830 nm center wavelength, 20 nm 3 dB width SLD could be multiplexed together with a 650 nm center wavelength, 15 nm 3 dB width SLD to obtain a/LCI information at two wavelengths. Further, as the various wavelengths become farther apart, it may be necessary to put in compensation components to account for the variation in index of refraction at the different wavelengths. For example, if one is using a 400 nm and an 800 nm wavelength, it may be the case that when the interferometer arms are path length matching for the 400 nm wavelength, they are mismatched for the 800 nm wavelength by more than the imaging depth available with the spectrometer (typically 1 to 2 mm).

The a/LCI systems and methods described herein can be clinically viable methods for assessing tissue health without the need for tissue extraction via biopsy or subsequent histopathological evaluation. The a/LCI systems and methods described herein can be applied for a number of purposes: for example, early detection and screening for dysplastic tissues, disease staging, monitoring of therapeutic action, and guiding the clinician to biopsy sites. The non-invasive, non-ionizing nature of the optical a/LCI probe means that it can be applied frequently without adverse affect. The potential of a/LCI to provide rapid results will greatly enhance its widespread applicability for disease screening.

Nuclear morphology measurement is also possible using the a/LCI systems and methods described herein. Nuclear morphology is a necessary junction between a cell's topographical environment and its gene expression. One application of the a/LCI systems and methods is to connect topographical cues to stem cell function by investigating nuclear morphology. There are several steps to achieve this. The first is improvement of the a/LCI systems and methods can be to use the swept-source light source approach described herein and create and implement light scattering models. The second is to provide nuclear morphology as a function of nanotopography. Finally, by connecting nuclear morphology with gene expression, the structure-function relationship of stem cells, e.g., human mesenchymal stem cells (hMSC), under the influence of nanotopographic cues can be established.

The a/LCI methods and systems described herein can also be used for cell biology applications. Accurate measurements of nuclear deformation, i.e., structural changes of the nucleus in response to environmental stimuli, are important for signal transduction studies. Traditionally, these measurements require labeling and imaging, and then nuclear measurement using image analysis. This approach is time-consuming, invasive, and unavoidably perturbs cellular systems. The a/LCI techniques described herein offer an alternative for probing physical characteristics of living systems. The a/LCI techniques disclosed herein can be used to quantify nuclear morphology for early cancer detection, as well as for noninvasively measuring small changes in nuclear morphology in response to environmental stimuli. With the a/LCI methods and systems provided herein, high-throughput measurements and probing aspherical nuclei can be accomplished. This is demonstrated for both cell and tissue engineering research. Structural changes in cell nuclei or mitochondria due to subtle environmental stimuli, including substrate topography and osmotic pressure, are profiled rapidly without disrupting the cells or introducing artifacts associated with traditional measurements. Accuracy of better than 3% can be obtained over a range of nuclear geometries, with the greatest deviations occurring for the more complex geometries.

In one embodiment disclosed herein, the a/LCI systems and methods described herein are used to assess nuclear deformation due to osmotic pressure. Cells are seeded at high density in chambered coverglasses and equilibrated with 500, 400 and 330 mOsm saline solution, in that order. Nuclear diameters are measured in micrometers to obtain the mean value+/−the standard error within a 95% confidence interval. Changes in nuclear size are detected as a function of osmotic pressure, indicating that the a/LCI systems and methods disclosed herein can be used to detect cellular changes in response to factors which affect cell environment. One skilled in the art would recognize that many biochemical and physiological factors can affect cell environment, including disease, exposure to therapeutic agents, and environmental stresses.

To assess nuclear changes in response to nanotopography, cells are grown on nanopatterned substrates which create an elongation of the cells along the axis of the finely ruled pattern. The a/LCI systems and processes disclosed herein are applied to measure the major and minor axes of the oriented spheroidal scatterers in micrometers through repeated measurements with varying orientation and polarization. A full characterization of the cell nuclei is achieved, and both the major axis and minor axis of the nuclei is determined, yielding an aspect ratio (ratio of minor to major axes).

The a/LCI systems and methods disclosed herein can also be used for monitoring therapy. In this regard, the a/LCI systems and methods are used to assess nuclear morphology and subcellular structure within cells (e.g., mitochondria) at several time points following treatment with chemotherapeutic agents. The light scattering signal reveals a change in the organization of subcellular structures that is interpreted using a fractal dimension formalism. The fractal dimension of sub-cellular structures in cells treated with paclitaxel and doxorubicin is observed to increase significantly compared to that of control cells. The fractal dimension will vary with time upon exposure to therapeutic agents, e.g. paclitaxel, doxorubicin and the like, demonstrating that structural changes associated with apoptosis are occurring. Using T-matrix theory-based light scattering analysis and an inverse light scattering algorithm, the size and shape of cell nuclei and mitochondria are determined. Using the a/LCI systems and methods disclosed herein, changes in sub-cellular structure (e.g., mitochondria) and nuclear substructure, including changes caused by apoptosis, can be detected. Accordingly, the a/LCI systems and processes described herein have utility in detecting early apoptotic events for both clinical and basic science applications.

Although embodiments disclosed herein have been illustrated and described herein with reference to preferred embodiments and specific examples thereof, it will be readily apparent to those of ordinary skill in the art that other embodiments and examples can perform similar functions and/or achieve like results. The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. All such equivalent embodiments and examples are within the spirit and scope of the present invention and are intended to be covered by the appended claims. It will also be apparent to those skilled in the art that various modifications and variations can be made to the present invention without departing from the spirit and scope of the invention. Thus, the disclosure is not intended to be limited to the examples and designs described herein, but is to be accorded the widest scope consistent with the principles and novel features disclosed herein.

What is claimed is:

1. A method of obtaining depth-resolved spectra of a sample for determining size and depth characteristics of scatterers within the sample, comprising the steps of:
generating light over a range of wavelengths from a swept-source light source onto a splitter, wherein the splitter splits the light to produce a reference beam and a sample input beam;
directing the sample input beam towards the sample at an angle;
receiving a spectral, angle-resolved scattered beam from the sample as a result of the sample input beam scattering from the sample over the range of wavelengths at a plurality of scattering angles;
mixing the reference beam with the spectral, angle-resolved scattered beam to produce a spectral, angle-resolved cross-correlated signal having depth-resolved information about the spectral, angle-resolved scattered beam;
detecting the spectral, angle-resolved cross-correlated signal at one or more of the plurality of scattering angles; and
processing the detected spectral, angle-resolved cross-correlated signal at one or more of the plurality of scattering angles to yield a spectral, angle-resolved cross-correlation profile having depth-resolved information about the sample at the one or more of the plurality of scattering angles.

2. The method of claim 1, wherein detecting the spectral, angle-resolved cross-correlated signal comprises detecting the spectral, angle-resolved cross-correlated signal at one or more of the plurality of scattering angles in a single scattering plane.

3. The method of claim 1, wherein detecting the spectral, angle-resolved cross-correlated signal at one or more of the plurality of scattering angles comprises detecting the spectral, angle-resolved cross-correlated signal at two or more of the plurality of scattering angles in multiple scattering planes.

4. The method of claim 1, further comprising determining structural information about the sample from the spectral, angle-resolved cross-correlation profile.

5. The method of claim 1, further comprising recovering size information about scatterers in the sample from the spectral, angle-resolved cross-correlation profile.

6. The method of claim 5, wherein recovering size information is comprised of comparing an angular scattering distribution of the scattered sample beam contained in the spectral, angle-resolved cross-correlated profile to a predicted analytically or numerically calculated angular scattering distribution of the sample.

7. The method of claim 6, wherein the predicted analytically or numerically calculated angular scattering distribution of the sample is a Mie theory or T-Matrix theory angular scattering distribution of the sample.

8. The method of claim 6, further comprising filtering the angular scattering distribution of the sample before the step of comparing.

9. The method of claim 1, further comprising determining depth-resolved information about the sample from the spectral, angle-resolved cross-correlation profile.

10. The method of claim 9, wherein cross-correlating the spectral, angled-resolved scattered sample beam with the reference beam is performed in a plurality of scans at a plurality of distances from the sample in time and yields a plurality of spectral, angle-resolved cross-correlation profiles about the sample.

11. The method of claim 10, wherein the steps of receiving, mixing, and detecting are performed for each of the plurality of scans;
wherein determining depth-resolved information about the sample comprises determining information about the sample from the plurality of spectral, angle-resolved cross-correlation profiles.

12. The method of claim 9, wherein determining depth-resolved information about the sample comprises converting the spectral, angle-resolved cross-correlation profile into the Fourier domain yielding the depth-resolved information about the sample as a function of scattering angle.

13. The method of claim 1, wherein receiving the spectral, angle-resolved scattered beam comprises receiving the spectral, angle-resolved scattered beam from the sample as a result of the sample input beam scattering from the sample over the range of wavelengths at a plurality of scattering angles at an end of a fiber bundle comprised of a plurality of fibers.

14. The method of claim 13, wherein the plurality of fibers in the fiber bundle are arranged to collect different angular distributions of the spectral, angle-resolved scattered beam.

15. The method of claim 13, further comprising carrying the sample input beam on a delivery fiber;
wherein directing the sample input beam towards to the sample at an angle comprises directing the sample input beam carried by the delivery fiber at the angle to the sample such that the specular reflection due to the sample is not received by the fiber bundle.

16. The method of claim 1, wherein scatterers in the spectral, angle-resolved scattered beam are cell nuclei.

17. The method of claim 1, further comprising measuring changes in nucleus size, shape, or organization as a function of the spectral, angle-resolved cross-correlation profile.

18. The method of claim 1, further comprising measuring changes in mitochondrion or other organelle size, shape or organization as a function of the spectral, angle-resolved cross-correlation profile.

19. The method of claim 1, further comprising monitoring changes in nucleus size, shape, organization to assess intentionally induced modifications of cell growth and type as a function of the spectral, angle-resolved cross-correlation profile.

20. An apparatus for obtaining depth-resolved spectra of a sample for determining size and depth characteristics of scatterers within the sample, comprising:
a swept-source light source configured to generate a light over a range of wavelengths;
a splitter configured to receive the light and split the light into a reference beam and a sample input beam;
a sample input beam path configured to direct the sample input beam towards to the sample at an angle;
a receiver configured to receive a spectral, angle-resolved scattered beam from the sample as a result of the sample input beam scattering from the sample over the range of wavelengths at a plurality of scattering angles;
a mixing element configured to mix the reference beam with the spectral, angle-resolved scattered beam to produce a spectral, angle-resolved cross-correlated signal having depth-resolved information about the spectral, angle-resolved scattered beam;
a detector configured to detect the spectral, angle-resolved cross-correlated signal at one or more of the plurality of scattering angles; and
a processing system configured to receive the detected spectral, angle-resolved cross-correlated signal at one or more of the plurality of scattering angles and produce a spectral, angle-resolved cross-correlation profile having depth-resolved information about the sample at the one or more of the plurality of scattering angles.

21. The apparatus of claim 20, wherein the detector is a one-dimensional detector configured to detect the spectral, angle-resolved cross-correlated signal at one or more of the plurality of scattering angles in a single scattering plane.

22. The apparatus of claim 20, wherein the detector is a two-dimensional detector configured to detect the spectral, angle-resolved cross-correlated signal at two or more of the plurality of scattering angles in multiple scattering planes.

23. The apparatus of claim 20, wherein the processing system is further configured to determine structural information about the sample from the spectral, angle-resolved cross-correlation profile.

24. The apparatus of claim 20, wherein the processing system is further configured to recover size information about scatterers in the sample from the spectral, angle-resolved cross-correlation profile.

25. The apparatus of claim 20, wherein the processing system is further configured to determine depth-resolved information about the sample from the spectral, angle-resolved cross-correlation profile.

26. The apparatus of claim 25, wherein the processing system is further configured to change the distance traveled by the spectral, angle-resolved scattered sample beam and the sample input beam.

27. The apparatus of claim 26, wherein the processing system is configured to receive a plurality of spectral, angle-resolved scattered beams from the sample as a result of the sample input beam scattering from the sample over the range of wavelengths at a plurality of scattering angles at the plurality of the distances.

28. The apparatus of claim 27, wherein the processing system is configured to determine depth-resolved information about the sample; and
determining the depth-resolved information about the sample comprises determining information about the sample from the plurality of spectral, angle-resolved cross-correlation profiles.

29. The apparatus of claim 25, wherein determining depth-resolved information about the sample comprises converting the spectral, angle-resolved cross-correlation profile into the Fourier domain yielding the depth-resolved information about the sample as a function of scattering angle.

30. The apparatus of claim 20, wherein the sample input beam path is a fiber optic path comprised of a delivery fiber.

31. The apparatus of claim 30, wherein the receiver is comprised of a collection fiber configured to receive the spectral, angle-resolved scattered beam from the sample.

32. The apparatus of claim 31, wherein the collection fiber is a fiber bundle comprised of a plurality of optical fibers arranged to collect different angular distributions of the spectral, angle-resolved scattered beam.

33. The method of claim 32, wherein the delivery fiber is directed towards the sample at angle such that the specular reflection due to the sample is not received by the fiber bundle.

34. The apparatus of claim 32, wherein the plurality of optical fibers possess the same or substantially the same spatial arrangement at distal and proximal ends of the plurality of optical fibers such that the fiber bundle is spatially coherent with respect to conveying the angular distribution of the spectral, angle-resolved scattered sample beam.

35. The apparatus of claim 33, wherein the plurality of fibers are broken out in a plurality of sections each comprising at least one of the plurality of optical fibers to receive the spectral, angle-resolved scattered beam from the sample at the plurality of scattering angles at an end of a fiber bundle comprised of a plurality of fibers.
